(19) United States
(12) Patent Application Publication
(10) Pub. No.: US 2013/0033410 A1
(43) Pub. Date: Feb. 7, 2013

(54) COMMUNICATION ELECTRONIC DEVICE AND ANTENNA STRUCTURE THEREIN

(71) Applicants: Kin-Lu Wong, New Taipei City (TW); Fang-Hsien Chu, New Taipei City (TW)

(72) Inventors: Kin-Lu Wong, New Taipei City (TW); Fang-Hsien Chu, New Taipei City (TW)

(21) Appl. No.: 13/329,317

(22) Filed: Dec. 18, 2011

(30) Foreign Application Priority Data
Aug. 5, 2011 (TW) 100128027

(51) Int. Cl. H01Q 1/48

(52) U.S. Cl. 343/848

(57) ABSTRACT

A communication electronic device includes an antenna structure at least having a grounding element and an antenna element. One edge of the grounding element has a notch, and the antenna element is disposed in the notch of the grounding element. The antenna element includes a feeding portion and a shorting portion, wherein the feeding portion at least includes a first segment, a second segment, and a third segment. There is a first coupling gap between the second segment of the feeding portion and a first shorting segment of the shorting portion which includes an open end of the shorting portion. There is a second coupling gap between the third segment of the feeding portion and a second shorting segment of a shorting portion which includes the shorting end of the shorting portion.

### BACKGROUND OF THE INVENTION

1. Field of the Invention

Noon The present invention relates to a communication electronic device, and more particularly, to a handheld communication electronic device having a compact antenna with two wide operating bands, wherein the antenna is disposed in a notch of an edge of the grounding element of the communication electronic device in order to reduce influences resulting from a user's hand.

2. Description of the Prior Art

With the progress of mobile communication technology, mobile communication devices are required to be light and small, such that small size, multi-band operations, as well as the integration of an internal antenna and other electronic elements on the system circuit board of the device become essential design considerations. The location of the antenna will affect influences resulting from a user's hand when the mobile communication device is in use. For example, in the conventional art, such as U.S. Pat. No. 7,768,466 entitled “Multiband folded loop antenna”, a three-dimensional mobile antenna is disclosed. The antenna is disposed at an edge of a grounding element, wherein the antenna must occupy the overall edge in order to achieve a wide band operation. As a result, the antenna cannot be closely integrated with the grounding element, which results in a waste of interior space of the device. In addition, when the mobile device is in use, such an antenna configuration may easily cause the radiation efficiency of the antenna to be affected by the user's hand.

Hence, how to provide a communication electronic device having an antenna with two wide operating bands at least covering 824 MHz to 960 MHz and 1710 MHz to 2170 MHz to satisfy the five-band WWAN operation has become an important topic in this field. In addition, the antenna can be disposed in a notch of the grounding element and the notch is located in a center region of an edge of the grounding element for increasing the distance between the antenna and the user's hand, so as to reduce influences resulting from the user's hand and improve the abovementioned problems existing in the prior art.

### SUMMARY OF THE INVENTION

It is therefore one of the objectives of the present invention to provide a communication electronic device having an antenna structure with two wide operating bands at least covering 824 MHz to 960 MHz and 1710 MHz to 2170 MHz, ensuring the antenna structure can satisfy requirements of the five-band WWAN operation. In addition, the antenna element can be disposed in a notch of a grounding element, wherein the notch is located in a center region of an edge of the grounding element for increasing the distance between the antenna element and the user's hand so as to reduce influences resulting from the user's hand.

According to an aspect of the present invention, a communication electronic device comprising an antenna structure is provided. The antenna structure may include a grounding element and an antenna element, wherein an edge of the grounding element includes a notch, and the antenna element is disposed in the notch of the grounding element. The antenna element may include a feeding portion and a shorting portion. The feeding portion at least includes a first segment, a second segment, and a third segment, wherein a first end of the first segment is a feeding end of the antenna element, the second segment is coupled to a second end of the first segment and is extended along a direction vertical to the first segment, and the third segment is coupled to the second segment. It should be noted that the first segment, the second segment, and the third segment form a U shape. The shorting portion includes a first shorting segment and a second shorting segment. Herein there is a first coupling gap between the second segment of the feeding portion and the first shorting segment of the shorting portion which includes an open end of the shorting portion, and there is a second coupling gap between the third segment of the feeding portion and the second shorting segment of the shorting portion which includes a shorting end of the shorting portion.

According to another aspect of the present invention, an antenna structure is provided. The antenna structure may include a grounding element and an antenna element, wherein an edge of the grounding element includes a notch, and the antenna element is disposed in the notch of the grounding element. The antenna element may include a feeding portion and a shorting portion. The feeding portion at least includes a first segment, a second segment, and a third segment, wherein a first end of the first segment is a feeding end of the antenna element, the second segment is coupled to a second end of the first segment and is extended along a direction vertical to the first segment, and the third segment is coupled to the second segment. It should be noted that the first segment, the second segment, and the third segment form a U shape. The shorting portion includes a first shorting segment and a second shorting segment. Herein there is a first coupling gap between the second segment of the feeding portion and the first shorting segment of the shorting portion which includes an open end of the shorting portion, and there is a second coupling gap between the third segment of the feeding portion and the second shorting segment of the shorting portion which includes a shorting end of the shorting portion.

In one embodiment of the present invention, the notch is located in a center region of the edge of the grounding element. In another embodiment of the present invention, the notch is located at a corner of the edge of the grounding element.

In one embodiment of the present invention, the first coupling gap is about 2 mm, and the second coupling gap is about 1.5 mm.

The shorting portion can be excited by the feeding portion; therefore the feeding portion and the shorting portion can be combined into a resonant loop path so as to excite a quarter-wavelength resonant mode at the lower frequencies (around 850 MHz) and a higher-order resonant mode at the higher frequencies (around 1700 MHz). In addition, by adding the microwave circuit to the feeding end of the feeding portion, another resonant mode can be excited at the lower frequencies (around 1000 MHz) for achieving a dual-resonance at the lower frequencies so as to form a first (lower-frequency) operating band at least covering the two-band GSM850/900 operation. Furthermore, a higher-frequency quarter-wavelength resonant mode can be excited by the feeding portion at 2100 MHz. These two higher-frequency resonant modes, which can be adjusted by using the first coupling gap and the second coupling gap, are combined to form a second (higher-frequency) operating band at least covering the three-band GSM1800/1900/UMTS operation.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a communication electronic device and an antenna structure disposed therein according to a first embodiment of the present invention.

FIG. 2 is a diagram illustrating the return loss of the communication electronic device and the antenna structure disposed therein according to a first embodiment of the present invention.

FIG. 3 is a diagram illustrating a communication electronic device and an antenna structure disposed therein according to a second embodiment of the present invention.

FIG. 4 is a diagram illustrating a communication electronic device and an antenna structure disposed therein according to a third embodiment of the present invention.

FIG. 5 is a diagram illustrating a communication electronic device and an antenna structure disposed therein according to a fourth embodiment of the present invention.

### DETAILED DESCRIPTION

The following description is of the best-contemplated mode of carrying out the present invention. A detailed description is given in the following embodiments with reference to the accompanying drawings.

Certain terms are used throughout the description and following claims to refer to particular components. As one skilled in the art will appreciate, manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

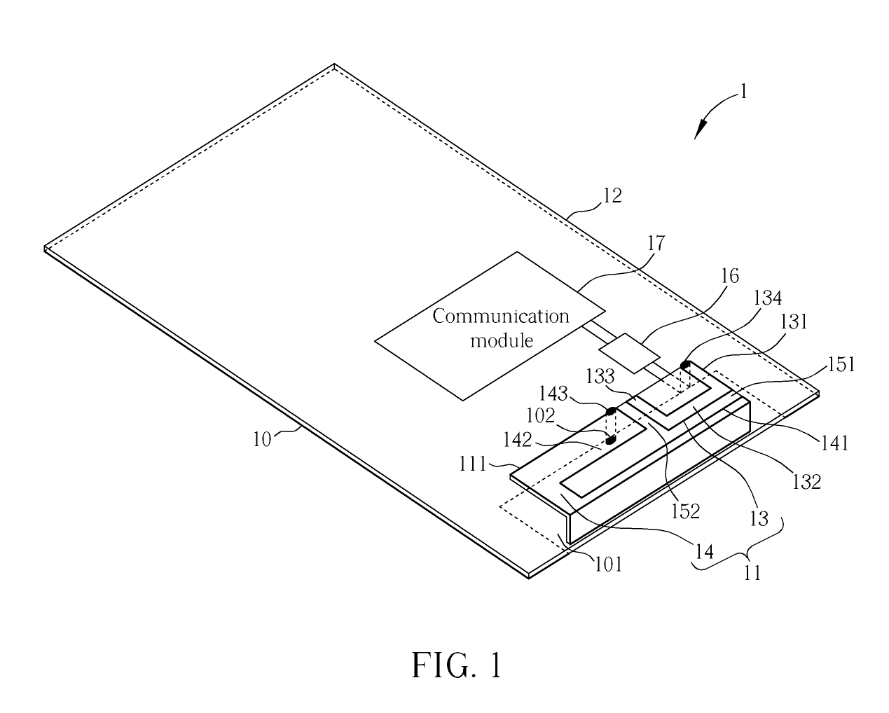

Please refer to FIG. 1, which is a diagram illustrating a communication electronic device 1 and an antenna structure disposed therein according to a first embodiment of the present invention. In this embodiment, the communication electronic device 1 may include, but is not limited to, a grounding element 10 and an antenna element 11, wherein the antenna element 11 is disposed in a notch 101 of the grounding element 10. The antenna element 11 may include a feeding portion 13 and a shorting portion 14. The feeding portion 13 at least includes a first segment 131, a second segment 132, and a third segment 133, wherein a first end of the first segment 131 is a feeding end 134 of the antenna element 11, and the second segment 132 is coupled to a second end of the first segment 131 and is extended along a direction vertical to the first segment 131. In addition, the first segment 131, the second segment 132, and the third segment 133 form a U shape. It should be noted that: there is a first coupling gap 151 between the second segment 132 of the feeding portion 13 and the first shorting segment 141 of the shorting portion 14 which includes an open end of the shorting portion 14, and there is a second coupling gap 152 between the third segment 133 of the feeding portion 13 and the second shorting segment 142 of the shorting portion 14 which includes a shorting end 143 of the shorting portion 14.

What calls for special attention is that: the shorting end 143 of the shorting portion 14 is further electrically connected to a shorting point 102 of the grounding element 10 through a metal conductor. Furthermore, in one embodiment, the communication electronic device 1 may further include a microwave circuit 16 coupled to the feeding end 134 of the feeding portion 13 of the antenna element 11, and thus the feeding portion 13 is electronically connected to the microwave circuit 16 and then electronically connected to a communication module 17. The microwave circuit 16 at least includes a chip inductor and a chip capacitor, wherein the chip inductor and the chip capacitor are in parallel connection so as to form an LC band-stop circuit for adjusting impedance matching of the antenna structure. Moreover, through the two different coupling gaps 151 and 152 existed between the feeding portion 13 and the shorting portion 14, the flexibility of the adjusting mechanism of the higher frequency bandwidth of the antenna structure can be increased.

In this embodiment, the first coupling gap 151 is about 2 mm, and the second coupling gap 151 is about 1.5 mm, but this in no way should be considered as a limitation of the present invention.

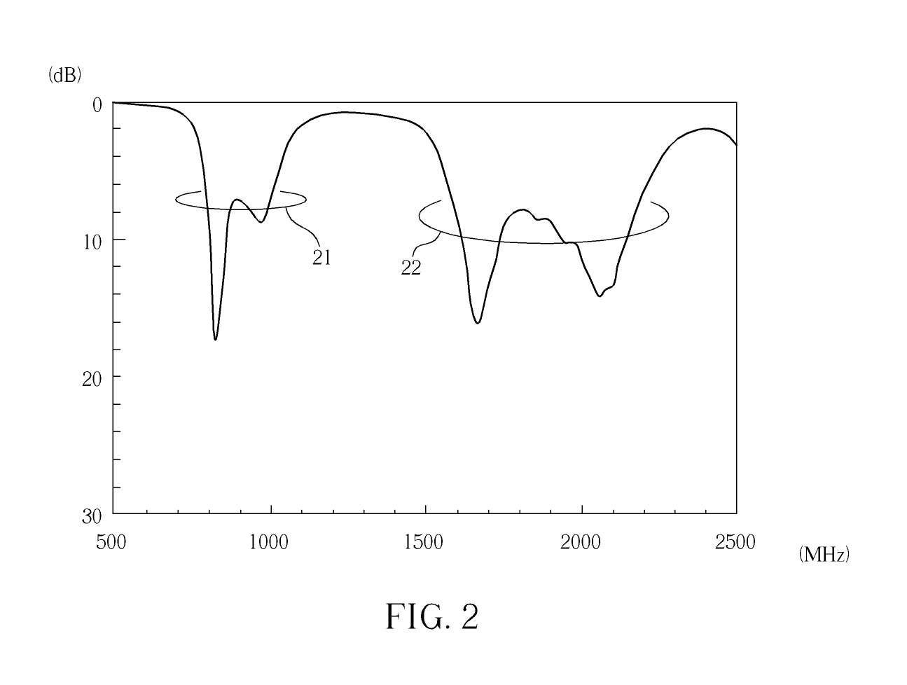

Please refer to FIG. 1 together with FIG. 2. FIG. 2 is a diagram illustrating the return loss of the communication electronic device 1 and the antenna structure disposed therein according to a first embodiment of the present invention. In this embodiment, the shorting portion 14 can be excited by the feeding portion 13; therefore the feeding portion 13 and the shorting portion 14 can be combined into a resonant loop path so as to excite a quarter-wavelength resonant mode at the lower frequencies (around 850 MHz) and a higher-order resonant mode at the higher frequencies (around 1700 MHz). In addition, by adding the microwave circuit 16 to the feeding end 134 of the feeding portion 13, another resonant mode can be excited at the lower frequencies (around 1000 MHz) for achieving a dual-resonance at the lower frequencies so as to form a first (lower-frequency) operating band (such as the first operating band 21 shown in FIG. 2) at least covering 824 MHz to 960 MHz. Furthermore, a higher-frequency resonant mode can be excited by the feeding portion 13 at 2100 MHz. These two higher-frequency resonant modes, which can be adjusted by using the first coupling gap 151 and the second coupling gap 152, are combined to form a second (higher-frequency) operating band (such as the second operating band 22 shown in FIG. 2) at least covering 1710 MHz to 2170 MHz; thereby the antenna structure can satisfy requirements of the five-band WWAN operation. Such an antenna structure has a simple structure and can be manufactured easily, which can satisfy requirements of practical applications.

FIG. 2 is a diagram illustrating the return loss of the communication electronic device 1 and the antenna structure disposed therein according to a first embodiment of the present invention. In this embodiment, the size of the communication electronic device 1 is as follows: the grounding element 10 has a length of 115 mm and a width of 60 mm; the notch 101 has a length of 40 mm and a width of 10 mm; and the system circuit board 12 has a length of 115 mm, a width of 60 mm, and a thickness of 0.8 mm. According to the experimental results and a 6-dB return-loss definition, the first operating band 21 of the communication electronic device 1 and its antenna structure may cover the two-band GSM850/900 operation (from about 824 MHz to 960 MHz), and the second operating band 22 may cover the three-band GSM1800/1900/UMTS operation (from about 1710 MHz to 2170 MHz), thereby the antenna structure can satisfy requirements of the five-band WWAN operation.

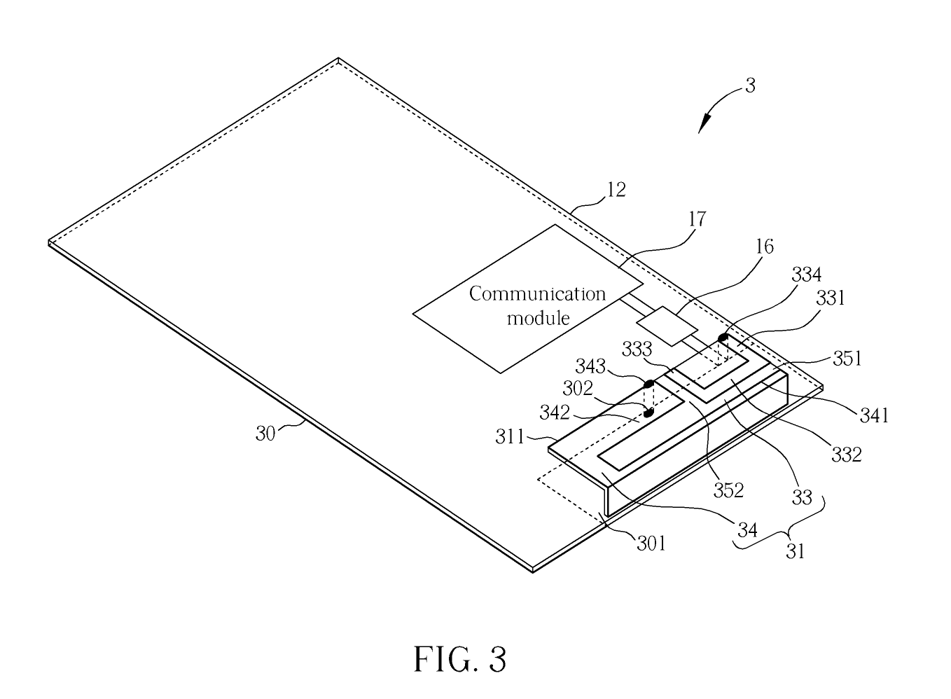

Please refer to FIG. 3, which is a diagram illustrating a communication electronic device 3 and an antenna structure disposed therein according to a second embodiment of the present invention. The structure of the communication electronic device 3 shown in the second embodiment is similar to that of the communication electronic device 1 shown in the first embodiment, and the difference between them is that: a notch 301 of the communication electronic device 3 is located at a corner of the edge of the grounding element 30. At this time, the antenna element 31 is not surrounded by adjacent grounding element 30, thereby wideband or multiband operations of the antenna structure can be easily achieved.

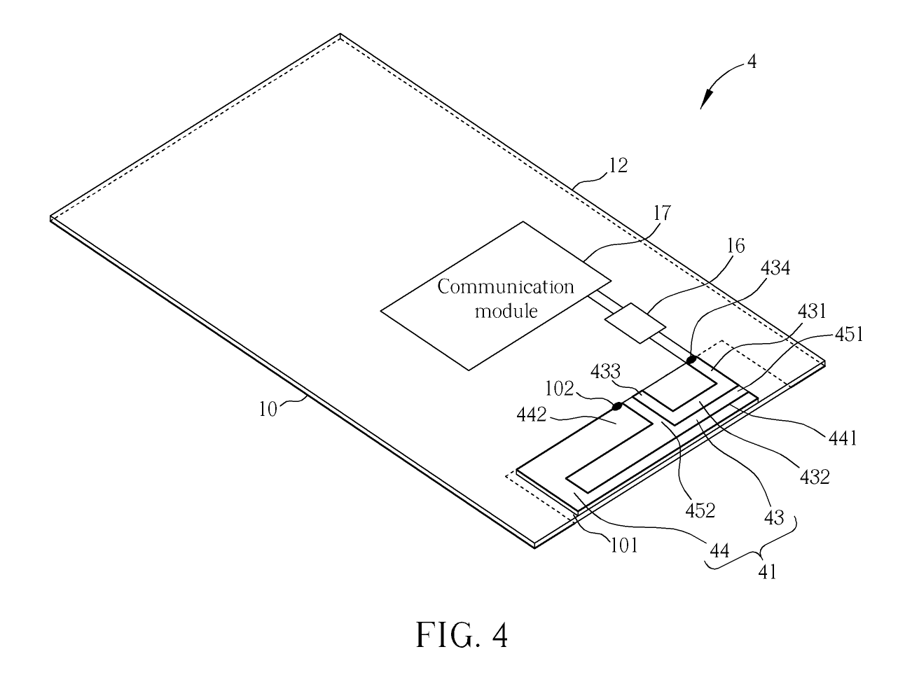

Please refer to FIG. 4, which is a diagram illustrating a communication electronic device 4 and an antenna structure disposed therein according to a third embodiment of the present invention. The structure of the communication electronic device 4 shown in the third embodiment is similar to that of the communication electronic device 1 shown in the first embodiment, and the difference between them is that: the antenna element 41 of the communication electronic device 4 shown in FIG. 4 can be directly disposed on the system circuit board 12 so as to form a planar structure. Moreover, the structure of the communication electronic device 4 of the third embodiment is similar to that of the communication electronic device 1 of the first embodiment, and forms two similar wideband operating bands covering the five-band WWAN operation.

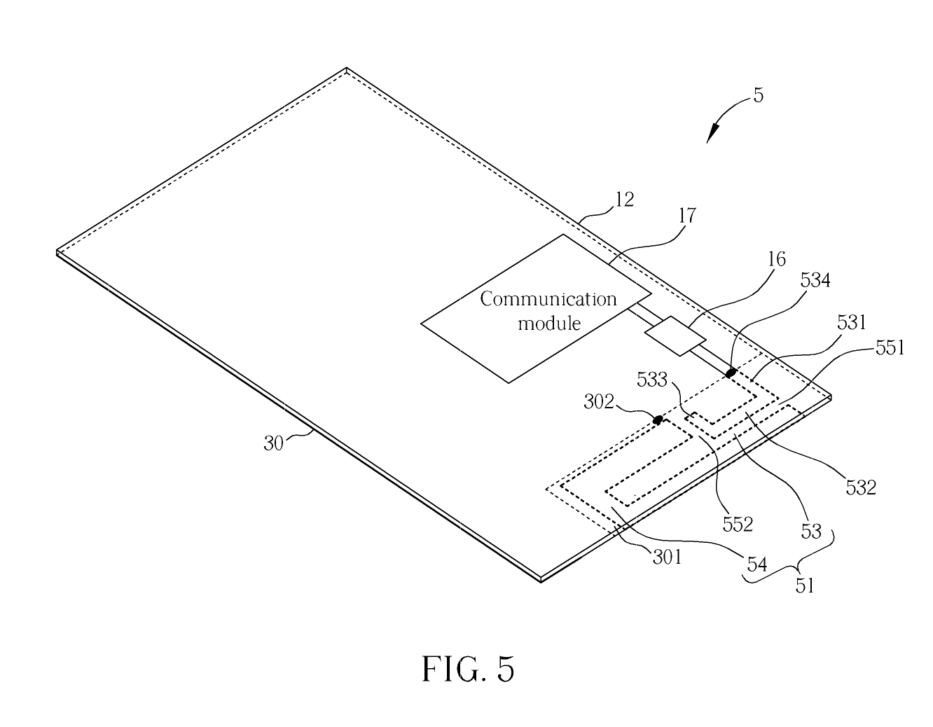

Please refer to FIG. 5, which is a diagram illustrating a communication electronic device 5 and an antenna structure disposed therein according to a fourth embodiment of the present invention. The structure of the communication electronic device 5 shown in the fourth embodiment is similar to that of the communication electronic device 1 shown in the first embodiment, and the difference between them is that: a notch 301 of the communication electronic device 5 is located at a corner of the edge of the grounding element 30, and the antenna element 51 of the communication electronic device 5 can be directly disposed on the system circuit board 12 so as to form a planar structure. At this time, the antenna element 51 is not surrounded by adjacent grounding element 30. What calls for special attention is that: the antenna element 51 and the grounding element 30 can be located on an identical plane (as is shown in FIG. 5) or different planes (as is shown in FIG. 1, FIG. 3, and FIG. 4) of the three-dimensional space. Moreover, the structure of the communication electronic device 5 of the fourth embodiment is similar to that of the communication electronic device 1 of the first embodiment, and forms two similar wideband operating bands covering the five-band WWAN operation.

Those skilled in the art should appreciate that various modifications of the communication electronic devices and the antenna structures shown in FIG. 1, FIG. 3, FIG. 4, and FIG. 5 may be made without departing from the spirit of the present invention. In addition, the number of the bends of the shorting portion is not limited, and the bending direction, the bending angle, and the bending shape of the bends should not be considered as a limitation of the present invention.

The abovementioned embodiments are presented merely to illustrate practicable designs of the present invention, and in no way should be considered to be limitations of the scope of the present invention. In summary, a communication electronic device and its antenna structure are provided, which include an antenna element capable of forming two wide operating bands. Such antenna element has a simple structure and can be integrated with a grounding element having a notch. The two operating bands of the antenna structure may cover the two-band GSM850/900 operation (from about 824 MHz to 960 MHz) and the three-band GSM1800/1900/UMTS operation (from about 1710 MHz to 2170 MHz), respectively, thereby achieving requirements of the five-band WWAN operation.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A communication electronic device comprising an antenna structure, the antenna structure at least comprising:
a grounding element, wherein one edge of the grounding element comprises a notch; and
an antenna element, disposed in the notch of the grounding element, the antenna element comprising:
a feeding portion, comprising:
a first segment, a first end of the first segment being a feeding end of the antenna element;
a second segment, coupled to a second end of the first segment, wherein the second segment is extended along a direction vertical to the first segment; and
a third segment, coupled to the second segment, wherein the first segment, the second segment, and the third segment form a U shape; and
a shoring portion, comprising a first shorting segment and a second shorting segment;
wherein there is a first coupling gap between the second segment of the feeding portion and the first shorting segment of the shorting portion which includes an open end of the shorting portion, and there is a second coupling gap between the third segment of the feeding portion and the second shorting segment of the shorting portion which includes a shorting end of the shorting portion.

2. The communication electronic device according to claim 1, further comprising:
a microwave circuit, coupled to the feeding end of the antenna element, arranged for increasing an operating bandwidth of the antenna structure.

3. The communication electronic device according to claim 2, wherein the microwave circuit at least comprises a chip inductor and a chip capacitor, and the chip inductor and the chip capacitor are in parallel connection so as to form an LC band-stop circuit.

4. The communication electronic device according to claim 1, wherein the antenna element comprises a first operating band and a second operating band, the first operating band covers about 824 MHz to 960 MHz, and the second operating band covers about 1710 MHz to 2170 MHz.

5. The communication electronic device according to claim 1, wherein the antenna element and the grounding element are located on different planes of the three-dimensional space.

6. The communication electronic device according to claim 1, wherein the antenna element and the grounding element are located on an identical plane of the three-dimensional space.

7. The communication electronic device according to claim 1, wherein the notch is located in a center region of the edge of the grounding element.

8. The communication electronic device according to claim 1, wherein the notch is located at a corner of the edge of the grounding element.

9. The communication electronic device according to claim 1, wherein the first coupling gap is about 2 mm.

10. The communication electronic device according to claim 1, wherein the second coupling gap is about 1.5 mm.

11. An antenna structure, comprising:
a grounding element, wherein one edge of the grounding element comprises a notch; and
an antenna element, disposed in the notch of the grounding element, the antenna element comprising:
a feeding portion, comprising:
a first segment, a first end of the first segment being a feeding end of the antenna element;
a second segment, coupled to a second end of the first segment, wherein the second segment is extended along a direction vertical to the first segment; and
a third segment, coupled to the second segment, wherein the first segment, the second segment, and the third segment form a U shape; and
a shoring portion, comprising a first shorting segment and a second shorting segment;
wherein there is a first coupling gap between the second segment of the feeding portion and the first shorting segment of the shorting portion which includes an open end of the shorting portion, and there is a second coupling gap between the third segment of the feeding portion and the second shorting segment of the shorting portion which includes a shorting end of the shorting portion.

12. The antenna structure according to claim 11, further comprising:
a microwave circuit, coupled to the feeding end of the antenna element, arranged for increasing an operating bandwidth of the antenna structure.

13. The antenna structure according to claim 12, wherein the microwave circuit at least comprises a chip inductor and a chip capacitor, and the chip inductor and the chip capacitor are in parallel connection so as to form an LC band-stop circuit.

14. The antenna structure according to claim 11, wherein the antenna element comprises a first operating band and a second operating band, the first operating band covers about 824 MHz to 960 MHz, and the second operating band covers about 1710 MHz to 2170 MHz.

15. The antenna structure according to claim 11, wherein the antenna element and the grounding element are located on different planes of the three-dimensional space.

16. The antenna structure according to claim 11, wherein the antenna element and the grounding element are located on an identical plane of the three-dimensional space.

17. The antenna structure according to claim 11, wherein the notch is located in a center region of the edge of the grounding element.

18. The antenna structure according to claim 11, wherein the notch is located at a corner of the edge of the grounding element.

19. The antenna structure according to claim 11, wherein the first coupling gap is about 2 mm.

20. The antenna structure according to claim 11, wherein the second coupling gap is about 1.5 mm.
